(19) United States
(12) Patent Application Publication
(10) Pub. No.: US 2025/0153691 A1
(43) Pub. Date: May 15, 2025

(54) BRAKE SYSTEM FOR A RAIL VEHICLE, AND METHOD FOR CONTROLLING SUCH A BRAKE SYSTEM

(71) Applicant: KNORR-BREMSE SYSTEME FÜR SCHIENENFAHRZEUGE GMBH, Munich (DE)

(72) Inventors: Martin STROBEL, Munich (DE); Thomas REISCHL, Munich (DE)

(21) Appl. No.: 18/839,350

(22) PCT Filed: Feb. 23, 2023
(86) PCT No.: PCT/EP2023/054515

§ 371 Date: Aug. 16, 2024

(30) Foreign Application Priority Data
Mar. 2, 2022 (DE) 10 2022 104 881.0

(51) Int. Cl. B60T 8/176; B60T 8/17; B60T 8/171; B60T 8/172

(52) U.S. Cl. CPC B60T 8/176; B60T 8/1705; B60T 8/171; B60T 8/172; B60T 2270/402

(57) ABSTRACT

Equipment, computer program product for executing a method, and a storage medium comprising such a computer program product provide a brake system for a rail vehicle that has at least two brake cylinders, at least one pneumatic brake control unit assigned to at least one rail vehicle unit of the rail vehicle, and at least two relay valves, which are each arranged between the at least one pneumatic brake control unit and at least one of the at least two brake cylinders and to which a supply pressure can be fed for conversion into a brake pressure, wherein the pneumatic brake control unit is connected to the at least two relay valves via a respective control pressure line and supplies the at least two relay valves with an anti-skid-corrected control pressure via the respective control pressure line.

### CROSS REFERENCE AND PRIORITY CLAIM

This patent application is a U.S. National Phase of International Patent Application No. PCT/EP2023/054515 filed Feb. 23, 2023, which claims priority to German Patent Application No. 10 2022 104 881.0, the disclosure of which being incorporated herein by reference in their entireties.

### FIELD

Disclosed embodiments relate to a brake system for a rail vehicle and to a method for controlling such a brake system. Furthermore, the disclosed embodiments relate to a rail vehicle including such a brake system, to a computer program product for executing the method, and to a storage medium including such a computer program product.

### BACKGROUND

For example, in brake systems with direct brakes for rail vehicles, electronically controlled anti-skid valves are installed near the bogies to ensure adequate anti-skid performance. One of the reasons for this is that effective wheel skid protection intervention must enable sufficiently rapid ventilation. A central installation of the anti-skid valves cannot ensure this due to the associated long piping and correspondingly large volumes.

### SUMMARY

Disclosed embodiments provide a brake system which technical utility with regard to the required installation space and/or reaction times and/or effort and costs.

In particular, a brake system for a rail vehicle is provided, wherein the brake system includes at least two brake cylinders, at least one pneumatic brake control unit which can be assigned to at least one rail vehicle unit of the rail vehicle, and at least two relay valves, each of which is arranged between the at least one pneumatic brake control unit and at least one of the at least two brake cylinders and to which a supply pressure can be fed for conversion into a brake pressure, wherein the pneumatic brake control unit is connected to the at least two relay valves via a respective control pressure line and is configured to supply the at least two relay valves with an anti-skid-corrected control pressure via the respective control pressure line.

### BRIEF DESCRIPTION OF THE FIGURES

Disclosed embodiments are described below with the aid of the accompanying drawings. More specifically:

FIG. 1 is a schematic representation of a brake system for a rail vehicle according to an exemplary prior art,

FIG. 2 is a schematic representation of a brake system for a rail vehicle according to a disclosed embodiment, and

FIG. 3 is a detailed schematic representation of a pneumatic brake control unit of the brake system according to FIG. 1.

### DETAILED DESCRIPTION

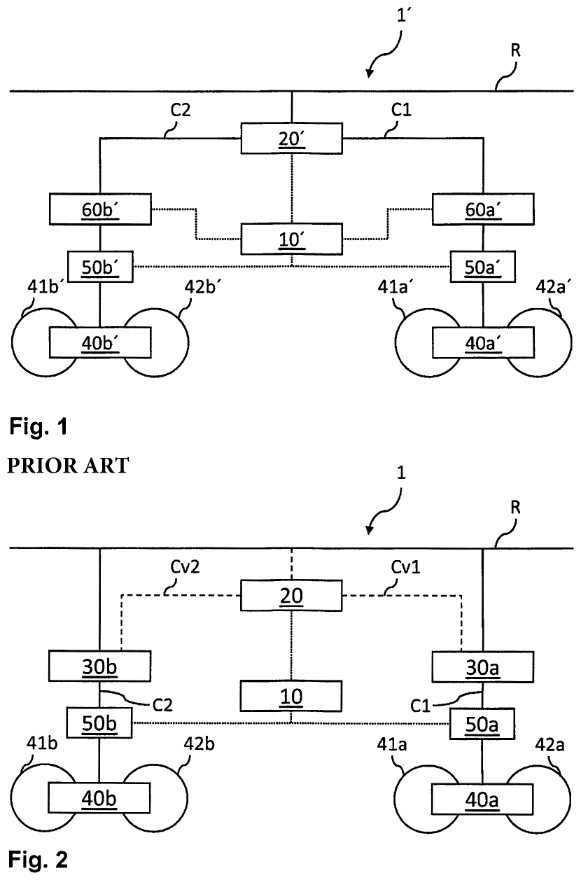

FIG. 1 shows such a brake system 1′ for braking the respective wheels of the bogies of a rail vehicle. By way of example, the corresponding description refers to two bogies of a wagon, wherein one bogie is represented by the wheels 41a′ and 42a′ or their corresponding axles and the other bogie is represented by the wheels 41b′ and 42b′ or their corresponding axles. Each bogie is assigned a corresponding brake cylinder 40a′, 40b′, which is configured here to brake all the wheels of an associated bogie. The brake cylinders are pneumatically controlled by a pneumatic brake control unit 20′. This is fed with a supply pressure R via a main pressure line and converts this for the respective brake cylinder 40a′ and 40b′ into a working pressure C1 for actuating the brake cylinder 40a′ and a working pressure C2 for actuating the brake cylinder 40b′.

The conversion takes place according to an activation of the pneumatic brake control unit 20′ by an electronic brake control unit 10′, for example in response to a service braking command, taking into account the axle loads. The electronic brake control unit 10′ also controls the anti-skid valves 60a′ and 60b′, which are each arranged between the pneumatic brake control unit 20′ and the respective brake cylinder 40a′ or 40b′ and are located near the bogie. If, for example, skidding of one or more axles or wheels of the wagon is detected, the electronic brake control unit 10′ controls the anti-skid valves 60a′ and 60b′ accordingly, so that at least one of the anti-skid valves 60a′, 60b′ temporarily corrects the respective working pressure C1, C2 by venting.

Accordingly, the working pressure C1, C2 corresponds to the brake pressure C1, C2 applied to the respective brake cylinder 40a′, 40b′ in a case in which the corresponding anti-skid valves 60a′, 60b′ do not engage. Otherwise, i.e. when the anti-skid valves 60a′, 60b′ engage, the brake pressure applied to the respective brake cylinder 40a′, 40b′ corresponds to a brake pressure C1*, C2* adapted to the anti-skid valves (not shown). A pressure sensor 50a′ and 50b′ is also arranged between the respective anti-skid valves 60a′, 60b′ and the respective brake cylinders 40a′, 40b′ in order to transmit relevant control values to the electronic brake control unit 10′.

According to the prior art described above, the supply pressure R is, therefore, passed both through the pneumatic brake control unit 20′ and then also through the anti-skid valves 60a′ and 60b′ in a form that is already adapted depending on the control. This requires a correspondingly available installation space, particularly due to the comparatively large piping cross-sections involved. In addition, this can also result in delayed reaction times depending on the volumes to be moved. Although the delayed reaction times can be kept within a tolerable range by keeping the components close together, this in turn restricts the design options. In addition, the necessary electrical control of the wheel-skid protection valves 60a′ and 60b′ by the electronic brake control unit 10′ requires a significant amount of electrical cabling.

In view of the above, disclosed embodiments provide a brake system which is improved over the prior art, in particular with regard to the required installation space and/or reaction times and/or effort and costs.

Disclosed embodiments provide a brake system for a rail vehicle, wherein the brake system has the following at least two brake cylinders, at least one pneumatic brake control unit which can be assigned to at least one rail vehicle unit of the rail vehicle, and at least two relay valves, each of which is arranged between the at least one pneumatic brake control unit and at least one of the at least two brake cylinders and to which a supply pressure can be fed for conversion into a brake pressure, wherein the pneumatic brake control unit is connected to the at least two relay valves via a respective control pressure line and is configured to supply the at least two relay valves with an anti-skid-corrected control pressure via the respective control pressure line.

The term “rail vehicle” can refer to a wagon of a train, a train itself, or a train combination. Accordingly, the term “rail vehicle unit of the rail vehicle” refers to the wagon itself in the case of a wagon as a rail vehicle, the train itself or a wagon of the train in the case of a train as a rail vehicle, and the train combination itself in the case of a train combination as a rail vehicle, a train of the train combination or a wagon of a train of the train combination. Accordingly, the at least one pneumatic brake control unit represents a central pneumatic brake control unit of a rail vehicle unit for the at least two relay valves.

As the pneumatic brake control unit provides the anti-skid-corrected control pressure for the at least two relay valves, a corresponding respective control pressure line from the pneumatic brake control unit to the at least two relay valves can be designed as piping with a comparatively small cross-section. The pressure to be adjusted to the anti-skid-corrected control pressure by the pneumatic brake control unit can be supplied via a supply-pressure feed line from a supply pressure line. The feed line can also be designed as piping with a comparatively small cross-section in the sense of a control pressure line. Starting from at least one supply pressure line, only lines such as piping with a comparatively large cross-section are, therefore, required for the respective supply of the supply pressure to the at least two relay valves. The supplies to the relay valves can originate from a common supply pressure line or from different supply pressure lines.

The basic idea of the brake system according to the disclosed embodiments is, thus, based on being able to carry out an anti-skid correction via a central pneumatic brake control unit for the at least two relay valves, wherein larger distances can be bridged with sufficient reaction time via the comparatively small cross-sections of the control pressure lines. The signal amplification in the sense of an amplification to a required volume flow for applying the desired brake pressure is then carried out by the relay valves controlled by the respective anti-skid corrected control pressure. In other words, it is not the working pressure that is anti-skid-corrected, but the control pressure.

The term “anti-skid-corrected control pressure” refers to a control pressure that is adjusted when an anti-skid correction requirement is present, but does not need to be adjusted in the absence of such a requirement. The anti-skid-corrected control pressure can, therefore, also be understood as a control pressure that takes the anti-skid requirement into account. If, for example, skidding is detected that requires an adjustment of the control pressure that would have to be applied if skidding had not occurred, the anti-skid-corrected control pressure is not only generated via the pneumatic brake control unit in accordance with the corresponding higher-level brake command, but is also adjusted in line with the anti-skid measure to be applied. If an anti-skid measure is not required, the anti-skid-corrected control pressure corresponds to the control pressure according to the corresponding higher-level brake command.

The anti-skid-corrected control pressure in the presence of skidding can be aimed at reducing the braking force for the wheels or axles associated with the skidding. Alternatively, the anti-skid-corrected control pressure in the presence of skidding can also be aimed at increasing the braking force for the wheels or axles not associated with skidding.

In principle, the intended pneumatic control and corresponding braking force generation described below is also equally possible hydraulically. If the term “pneumatic” is used, it can also be used interchangeably with the term “hydraulic” or can include it. For well-known reasons, pneumatic systems are often preferred in conjunction with rail vehicles.

In a disclosed embodiment, the pneumatic brake control unit is configured to provide the anti-skid-corrected control pressure for at least one of the at least two relay valves independently of the anti-skid-corrected control pressure for the at least one other of the at least two relay valves.

The at least two relay valves can, therefore, be controlled independently of each other via the pneumatic brake control unit, each with different anti-skid-corrected control pressures.

In a disclosed embodiment, the pneumatic brake control unit has a main relay valve unit for providing a primary control pressure, in particular the anti-skid-corrected control pressure.

The main relay valve unit can, for example, initially adjust the control pressure to a primary control pressure as a control pressure adjusted in accordance with the corresponding higher-level brake command. Alternatively, the primary control pressure can also correspond directly to the snit-skid-corrected control pressure. In this case, the main relay valve unit directly takes the required anti-skid measure into account. If the primary control pressure is not already adjusted to the anti-skid-corrected control pressure by the main relay valve unit, the primary control pressure can at least correspond to the control pressure without anti-skid correction in accordance with the higher-level braking command. Alternatively or additionally, the primary control pressure can be adapted to a load-corrected control pressure via the main relay valve unit.

The main relay valve unit has at least one main relay valve. The main relay valve can be controlled by a main relay valve control pressure with comparatively even smaller line cross-sections, as only the control pressure is controlled.

In particular, the pneumatic brake control unit has at least one valve unit in a control pressure line on the main relay unit output side between the main relay valve and at least one of the at least two relay valves, which valve unit is configured to adapt the primary control pressure of the main relay valve unit to a secondary control pressure, in particular the anti-skid-corrected control pressure.

Thus, for example, the primary control pressure, which is forwarded from the main relay valve unit to the at least one valve unit, can be further adapted to the secondary control pressure. The control pressure line on the main relay unit output side thus relates to the control pressure line for forwarding the control pressure for the downstream relay valves, not a control line for providing a control pressure for controlling the at least one main relay valve.

If the primary control pressure already corresponds to the anti-skid-corrected control pressure, the at least one valve unit, which for example has a control valve, such as an electronic pressure control valve, or is designed as such, can make further individual adjustments, for example with regard to a load, brake and/or wheel condition. However, if the primary control pressure does not initially correspond to the anti-skid-corrected control pressure, the necessary adjustment of the primary control pressure to the anti-skid-corrected control pressure can be carried out as a secondary control pressure via the at least one valve unit.

The anti-skid-corrected control pressure can thus be provided via the main relay valve unit or the at least one valve unit. However, it is also possible to configure both the main relay valve unit and the at least one valve unit in such a way that they are each capable of providing the anti-skid-corrected control pressure. The provision by one or the other unit can, for example, take place according to the anti-skid measure to be taken or also depending on the pneumatic signal level to be provided. The main relay valve unit and the at least one valve unit can also work together proportionally to provide the anti-skid-corrected control pressure. Similarly, the main relay valve unit and the at least one valve unit can also be configured in such a way that they can each perform redundant anti-skid correction of the control pressure. Accordingly, the at least one valve unit can take over the generation of the anti-skid-corrected control pressure from the main relay valve unit if the latter fails, and vice versa.

Optionally, the pneumatic brake control unit has at least one control pressure line on the main relay unit output side and/or at least one control pressure line portion on the main relay unit output side for each of the at least two relay valves. At least one valve unit is arranged at least in each of the control pressure lines on the main relay unit output side and/or in each control pressure line portion on the main relay unit output side.

Via the at least one control pressure line on the main relay unit output side for each of the at least two relay valves, for example, each of the at least two relay valves can be provided with a different anti-skid-corrected control pressure. This can be achieved either by the main relay valve unit having a separate main relay valve for each control pressure line on the main relay unit output side, by the main relay valve unit having a further pressure adjustment unit for each control pressure line on the main relay unit output side downstream of a main relay valve and/or by the at least one valve unit being arranged in the respective control pressure line on the main relay unit output side.

Alternatively, or additionally, a control pressure line on the main relay unit output side can branch into at least two control pressure line portions on the main relay unit output side. As a result, it is then possible, for example, to provide a different anti-skid-corrected control pressure to each of the relay valves connected to the respective control pressure line portion on the main relay unit output side. The different provision can take place via the valve unit arranged in the respective control pressure line portion on the main relay unit output side. The alternative configuration in relation to the at least two control pressure line portions on the main relay unit output side results, for example, with two relay valves. In the case of four relay valves, for example, a combination of two relay valves can be connected to a control pressure line on the main relay unit output side with two control pressure line portions on the main relay unit output side for each of the two relay valves.

In a disclosed embodiment, the pneumatic brake control unit has a control unit that is configured to control the main relay valve unit and/or the at least one valve unit via a control line.

The control unit is, for example, an electronic control unit that has at least one input for a brake command in order to control the main relay valve unit and/or the at least one valve unit accordingly. In addition, an anti-skid signal can be fed to the control unit via the at least one or another signal input in order to control the main relay valve unit and/or the at least one valve unit in such a way that the anti-skid-corrected control pressure is generated. The anti-skid signal can, for example, be a signal from a wheel speed sensor. The signal from the wheel speed sensor can be supplied directly as a control signal for a corresponding anti-skid correction or first processed by the control unit. In the latter case, the control unit can be configured in such a way that the control unit itself determines the anti-skid correction to be made. The anti-skid correction can be made depending on a braking mode, a current operating mode and/or a risk assessment. As an alternative or in addition to forwarding an anti-skid signal via a sensor representing skidding, the anti-skid signal can also be forwarded to the control unit of the pneumatic brake control unit via a higher-level control system, such as a central rail vehicle control unit.

The main relay valve unit and/or the at least one valve unit can be actuated pneumatically via the control line in the sense of providing a control pressure or by signaling. If, for example, the main relay valve unit is actuated by signaling, it in turn has components for generating a control pressure for the at least one main relay valve. Alternatively or additionally, the control line can directly conduct a main relay control pressure from the control unit to the at least one main relay. The control line for the control of the main relay valve unit and/or the at least one valve unit by the control unit is a control unit control line, i.e., not the control pressure line for the anti-skid-corrected control pressure. In principle, however, it is possible for the pressure supply to the control unit to be branched off from a control pressure line on the main relay unit input side and/or the control pressure line on the valve unit input side via the control unit control line when the main relay valve unit and/or the at least one valve unit is pneumatically controlled.

In particular, a pressure sensor is arranged in a control pressure line on the main relay unit input side and is connected to the control unit for signaling purposes.

The pressure sensor can thus transmit to the control unit the inlet pressure to be adjusted to the anti-skid-corrected control pressure in order to make the corresponding adjustment more precise. Accordingly, fluctuations in the inlet pressure or other changes are taken into account by the control unit. Accordingly, depending on the signal from the pressure sensor, the control unit can also be designed to detect a fault and forward a warning message and/or initiate emergency operation, for example in conjunction with braking.

In a disclosed embodiment, the pneumatic brake control unit has an emergency brake control unit that is configured to control the main relay valve unit and/or the at least one valve unit via a control line.

The emergency brake control unit can be provided as part of the control unit or separately from the control unit. In particular, the emergency brake control unit and units controlled thereby are configured in such a way that the control performed by the emergency brake control unit is given priority or, if necessary, suspends other controls that oppose or hinder the execution of the control by the emergency brake control unit.

In particular, the emergency brake control unit has at least one emergency brake valve, which can be actuated in particular by the control unit.

Accordingly, the emergency brake control unit can be operated as a pneumatic emergency brake control unit, which is controlled by the control unit for signaling purposes. The control unit can, for example, specify the emergency brake control pressure to be applied to the emergency brake control unit for the main relay valve unit. In this case, the emergency brake control pressure represents the control pressure for the at least one main relay valve for generating the primary control pressure for the downstream relay valves.

In a disclosed embodiment, at least one pressure sensor is arranged in the control pressure line on the main relay unit output side between the main relay valve unit and at least one of the at least two relay valves, in particular between at least one of the valve units and the respective relay valve, optionally between each of the valve units and the respective relay valve.

This means that the adjustment of the anti-skid-corrected control pressure can be monitored and/or controlled by the main relay valve unit and/or the at least one valve unit. The output signals of the corresponding pressure sensor can, for example, be passed on to the control unit of the pneumatic brake control unit and/or to a higher-level control system, such as a central rail vehicle control unit.

In a disclosed embodiment, the relay valves are arranged as local relay valves close to the brake cylinders assigned to them, in particular in the area of a bogie of the rail vehicle unit that can be assigned to the respective brake cylinder.

Accordingly, the brake pressure to be applied to the respective brake cylinders can be generated locally by the relay valve assigned to the respective brake cylinder. Consequently, a comparatively large line cross-section of a brake pressure line from the respective relay valves to the respective brake cylinders required for this can be kept to a tolerable length in terms of the required reaction times. In other words, the local relay valves can be used to amplify an anti-skid-corrected control pressure, which is applied to the respective local relay valves, to the required brake pressure volume flow. The anti-skid-corrected control pressure can be generated elsewhere, in particular centrally, as the comparatively smaller line cross-sections to be provided for forwarding to the relay valves allow longer distances to be bridged with sufficient response time.

For example, a local relay valve can be provided for each bogie, via which local relay valve the brake pressure is supplied to each brake cylinder of the bogie in accordance with the anti-skid-corrected control pressure specified for the local relay valve. The respective local relay valve is, for example, arranged close to the respective bogie, in particular on or in the bogie.

In order to be able to brake not only the bogies, but also individual axles of the bogies independently, one relay valve can be provided for each axle. The same applies to individual wheels in the case of split axles.

According to further technical utility, the disclosed embodiments relate to a method for controlling a brake system described above, and including providing a supply pressure for each of the at least two relay valves, controlling the at least two relay valves via the pneumatic brake control unit with an anti-skid-corrected control pressure, and forwarding a respective brake pressure resulting from the supply pressure and the anti-skid-corrected control pressure to the at least one brake cylinder assigned to the respective relay valve.

As already described above, the supply pressure can be provided to the at least two relay valves via comparatively large supply cross-sections to achieve the required volume flow. This derived supply pressure is then converted into a brake pressure or brake cylinder pressure in accordance with the control pressure applied to the respective relay valve. The supply pressure can be derived from a supply pressure line. The lines of the line system with the comparatively large line cross-section can also be referred to as main pressure lines.

The control of the relay valves via the anti-skid-corrected control pressure, which is generated in the pneumatic control unit, is then fed to the respective relay valves via lines with a comparatively small cross-section.

In a disclosed embodiment of the method, the anti-skid-corrected control pressure is set via the main relay valve unit described above and/or the at least one valve unit described above.

The method features described in the above description of the brake system or device features that can be equated with method features relate to equally advantageous further embodiments of the method.

According to further technical utility, the presently disclosed embodiments relate to a rail vehicle including a brake system as described above, wherein the brake control unit is arranged in a rail vehicle unit of the rail vehicle and the at least two relay valves are each associated with at least one bogie, in particular arranged on or in the bogie.

Accordingly, the rail vehicle as a whole or a rail vehicle unit of the rail vehicle can have the pneumatic brake control unit as at least one central pneumatic brake control unit, which transmits a respective anti-skid-corrected control pressure via control pressure lines to local relay valves, which are locally assigned to at least one bogie in each case, in particular to each brake cylinder of a bogie. However, the rail vehicle as a whole or a related rail vehicle unit can also have several of the brake systems described above, wherein the respective pneumatic brake control units centrally control at least two local relay valves via a respective anti-skid-corrected control pressure.

The respective brake system can be controlled independently via the pneumatic brake control unit, which then has corresponding signal inputs for a brake command and anti-skid events. However, the pneumatic brake control unit can also be controlled alternatively or additionally via a higher-level electronic brake control unit.

The vehicle features described in the above description of the brake system or the method, or device and/or method features that can be equated with vehicle features, relate equally to advantageous developments of the vehicle according to the disclosed embodiments.

According to further technical utility, a computer program product is provided that includes code which, when executed on a data processing unit, cause the data processing unit to perform the method described above.

According to further technical utility, a storage medium is provided for reading by a data processing unit, wherein the storage medium comprises a computer program product according to the above paragraph.

The computer program product or storage medium advantageously makes it possible to design existing data processing units for carrying out the method described above. Thus, a rail vehicle which has a data processing unit can also be designed to carry out the method described above.

The embodiments described above and below are not to be regarded as limiting to the subject of the invention. Rather, further subjects according to the disclosed embodiments can be obtained by supplementing, omitting or exchanging individual features.

FIG. 1 shows a schematic representation of a brake system 1′ for a rail vehicle according to an exemplary prior art.

The brake system 1′ shown in FIG. 1 corresponds to the brake system 1′ already described in the prior art.

FIG. 2 shows a schematic representation of a brake system 1 for a rail vehicle according to a disclosed embodiment.

In a disclosed embodiment, the brake system 1 is shown as a brake system for a wagon as a rail vehicle unit of a rail vehicle. The wagon has two bogies. One bogie is represented by the wheels 41a, 42a, which in turn represent respective axles of the bogie. The wheels 41a, 42a or the respective axles can be braked via a brake cylinder 40a arranged in or on the bogie. The other bogie is similarly represented by the wheels 41b, 42b, which in turn represent the respective axles of the bogie. The wheels 41b, 42b or the respective axles can be braked via a brake cylinder 40b arranged in or on the bogie. In alternative embodiments, several brake cylinders can also be arranged on a bogie.

A respective relay valve 30a, 30b is assigned to each of the brake cylinders 40a, 40b. One relay valve 30a converts a supply pressure R, which is derived from a supply pressure line, into a brake pressure C1, which is supplied to the brake cylinder 40a, as a function of an anti-skid-corrected control pressure Cv1. Similarly, the other relay valve 30b converts the supply pressure R, which is also derived from the supply pressure line, into a brake pressure C2, which is fed to the brake cylinder 40a, as a function of an anti-skid-corrected control pressure Cv2. The lines for guiding the supply pressure R to the relay valves 30a, 30b and the respective brake pressure C1, C2 from the respective relay valves 30a, 30b to the respective brake cylinders 40a, 40b can generally be referred to as main pressure lines. Compared to the control pressure lines described later, the main pressure lines have a relatively large cross-section in order to enable the required volume flow or to sufficiently amplify the control pressure signal applied.

To generate the respective anti-skid corrected control pressure Cv1, Cv2, the relay valves 30a, 30b are connected to a pneumatic brake control unit 20 via a control pressure line. The pneumatic brake control unit 20 is in turn connected to the supply pressure line via a control pressure line. Accordingly, the pneumatic brake control unit 20 is supplied with the supply pressure R to generate the anti-skid-corrected control pressures Cv1, Cv2. The control pressure line has a comparatively small cross-section in relation to the supply pressure line.

To control the pneumatic brake control unit 20, the brake system 1 has an electronic brake control unit 10. In a disclosed embodiment, this is a central electronic brake control unit 10, which controls the pneumatic brake control unit 20 both in accordance with an incoming brake control command and in accordance with incoming anti-skid signals. Alternatively, the pneumatic brake control unit 20 can also comprise the electronic brake control unit 10. If, in such a case, the pneumatic brake control unit 20 is provided as a central pneumatic brake control unit 20 for the rail vehicle unit or even the entire rail vehicle, the electronic brake control unit 10 also forms a corresponding central electronic brake control unit. Alternatively, the pneumatic brake control unit 20 and/or the electronic brake control unit 10 can also be controlled by another higher-level control system.

The pneumatic brake control unit 20 is controlled via the electronic brake control unit 10 via a control line. The electronic brake control unit is also connected via control lines to pressure sensors 50a, 50b, which are each arranged between the relay valves 30a, 30b and the brake cylinders 40a, 40b assigned to them. These transmit pressure signals representing the respective brake pressure C1, C2 to the electronic brake control unit 10, which can be used, for example, to monitor the proper functioning, the control and/or to output warning messages.

A disclosed embodiment of the brake system 1, therefore, may have three line types in principle. The supply pressure line, the lines leading from it to the relay valves, and the lines leading from the relay valves to the brake cylinders can be referred to here as lines of a first line type. Lines of the first line type can be referred to as main pressure lines. These main pressure lines have a comparatively large cross-section. The main pressure lines are marked with continuous lines in the figures. As lines of a second line type, control pressure lines run from the supply pressure line or a corresponding main pressure line to the pneumatic brake control unit 20 and then to the respective relay valves 30a, 30b. These control pressure lines have a comparatively smaller cross-section in relation to the main pressure lines. Control pressure lines are shown in the figures by dashed lines. In other embodiments, the main pressure lines and control pressure lines can also have the same or at least a similar cross-section. However, the use of comparatively smaller cross-sections can be advantageous, at least with regard to the associated reaction times, or enable longer line paths. In addition, the cross-sections of individual main pressure lines and/or main pressure line portions can differ from one another. This applies equally to the control pressure lines and/or control pressure line portions. Lastly, control lines for controlling the pneumatic brake control unit 20 by the electronic brake control unit 10 and for transmitting signals from the pressure sensors 50a, 50b to the electronic brake control unit 10 are provided as lines of a third line type. In a disclosed embodiment, the signals are transmitted via the control lines by means of electrical signals. Alternatively or additionally, other signal forms, such as pneumatic signals, can also be provided. The control lines are represented by dotted lines in the figures. To clarify, it should be noted that the control pressure lines refer to lines that can provide the control pressure for the relay valves, i.e., carry the volume to be adjusted for this purpose. In contrast, control lines refer to the lines for controlling the components for adjusting the control pressure.

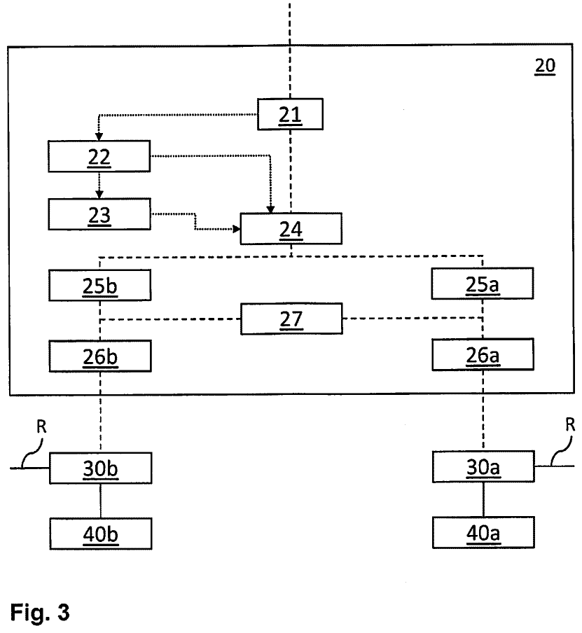

FIG. 3 shows a detailed schematic representation of a pneumatic brake control unit 20 of the brake system 1 according to FIG. 1.

In a disclosed embodiment, the brake control unit 20 comprises a main relay valve unit 24 as well as a control unit 22 and an emergency brake valve 23, wherein the main relay valve unit 24 can be controlled via the control unit 22 and/or the emergency brake valve 23. A pressure sensor 21 is arranged upstream of the main relay unit 24 in a control pressure line on the brake control unit input side, which control pressure line can be pressurized by the supply line. This pressure sensor 21 is connected to the control unit 22 via a control line, so that the control unit 22 can take into account the pressure currently supplied to the main relay valve unit 24 during actuation. In addition, the control unit 22 specifies an emergency braking pressure for the emergency brake valve 23, which emergency braking pressure is used to actuate the main relay valve unit 24 in the event of emergency braking.

The main relay valve unit 24 has a main relay valve (not shown), which converts the inlet pressure into a control pressure for the relay valves 30a, 30b depending on the control by the control unit 22 or the emergency brake valve 23. This control pressure is then discharged via a control pressure line on the main relay valve unit output side, which branches off to the respective relay valves 30a, 30b. A control valve unit 25a, as an example of a valve unit, is arranged in a control pressure line branch on the main relay valve unit output side leading to the one relay valve 30a, which converts the control pressure coming from the main relay valve unit 24 into an anti-skid-corrected control pressure Cv1 for the one relay valve 30a. The anti-skid correction can be carried out by controlling the control valve unit 25a by the control unit 22 and/or by an external signal transmission via the electronic brake control unit 10 and/or another unit that detects or determines the initiation of an anti-skid measure. The resultant anti-skid-corrected control pressure Cv1 is then forwarded to the one relay valve 30a. The pneumatic brake control unit 20 also has a pressure sensor 26a between the control valve unit 25a and the one relay valve 30a, via which the anti-skid-corrected control pressure can be monitored and/or used for further control and/or output for further use. Similarly, the control pressure coming from the main relay valve unit 24 is converted into an anti-skid-corrected control pressure Cv2 for the other relay valve 30b via a control valve unit 25b. A pressure sensor 26b is also provided between the control valve unit 26b and the relay valve 30b in the control pressure line portion on the main relay valve unit output side for the other relay valve 30b. In addition, the pneumatic brake control unit 20 has a connecting valve 27 that can connect the respective control pressure line portions on the control valve unit output side to each other. The connecting valve makes it possible, for example, that in normal operation the two anti-skid-corrected control pressures Cv1, Cv2 and thus the brake pressures C1, C2 can be controlled with only one of the two valve units 25a, 25b. This means that the operation of the valve unit 25a, 25b that is not currently being used can be suspended, which reduces the energy consumption and the number of valve cycles. The operation of both valve units 25a, 25b can be provided if fast reaction times are required and/or different anti-skid-corrected control pressures Cv1, Cv2 and thus different brake pressures C1, C2 are to be applied.

In a disclosed embodiment, the anti-skid corrected control pressure Cv1, Cv2 is individually anti-skid-corrected for each of the relay valves 30a, 30b via the control valve units 25a, 25b. Alternatively, the anti-skid correction of the control pressure can also be carried out by the main relay valve unit 24. The relay valves 30a, 30b can then, for example, be given the same anti-skid-corrected control pressure Cv1, Cv2, which can then be individually adjusted and/or switched on and off in the respective control pressure line portions by the respective control valve units 25a, 25b in accordance with other specifications. In a further alternative, the main relay valve unit has one main relay valve for each relay valve 30a, 30b or, in the case of groups of relay valves, one main relay valve for each group and a corresponding control pressure line output for each main relay valve. Accordingly, one control pressure line per main relay valve can be routed to the respective relay valve 30a, 30b or a corresponding group of relay valves. In such a configuration, each of the main relay valves can individually provide the anti-skid-corrected control pressure Cv1, Cv2.

In a constellation in which the control valve units 25a, 25b or such valve units do not contribute to the anti-skid correction and/or no other further adjustment and/or switching on and off of the anti-skid-corrected control pressure is provided, these valve units can also be omitted.

The invention is not limited to the disclosed embodiments described. In particular, features described with respect to the embodiment, otherwise described variants and developments of the invention may be combined with one another, provided that they are not reasonably mutually exclusive.

### LIST OF REFERENCE SIGNS

1, 1′ brake system
10, 10 electronic brake control unit
20, 20′ pneumatic brake control unit
21 pressure sensor
22 control unit
23 emergency brake valve
24 main relay valve unit
25a, 25b control valve unit (valve unit)
26a, 26b pressure sensor
27 connecting valve
30a, 30b relay valve
40a, 40a′, 40b, 40b′ brake cylinder
41a, 41a′, 42a, 42a′ wheels (brake cylinders 40a, 40a′)
41b, 41b′, 42b, 42b′ wheels (brake cylinders 40b, 40b′)
50a, 50a′, 50b, 50b′ pressure sensor
60a′, 60b′ anti-skid valve
C1, C2 working pressure (brake pressure)
Cᵥ1, Cᵥ2 control pressure
R supply pressure
[symbol] main pressure line
[symbol] control pressure line
[symbol] control line

1. A brake system for a rail vehicle, the brake system comprising:
at least two brake cylinders;
at least one pneumatic brake control unit assignable to at least one rail vehicle unit of the rail vehicle; and
at least two relay valves, which are each arranged between the at least one pneumatic brake control unit and at least one of the at least two brake cylinders and to which a supply pressure is fed for conversion into a brake pressure,
wherein the pneumatic brake control unit is connected to the at least two relay valves via a respective control pressure line and is configured to supply the at least two relay valves with an anti-skid-corrected control pressure via the respective control pressure line.

2. The brake system of claim 1, wherein the pneumatic brake control unit is configured to provide the anti-skid-corrected control pressure for at least one of the at least two relay valves independently of the anti-skid corrected control pressure for the at least one other of the at least two relay valves.

3. The brake system of claim 1, wherein the pneumatic brake control unit has a main relay valve unit providing primary control pressure for the anti-skid-corrected control pressure for one of the at least two relay valves.

4. The brake system of claim 3, wherein the pneumatic brake control unit has at least one valve unit in a control pressure line on the main relay unit output side between the main relay valve and at least one of the at least two relay valves, wherein the at least one valve unit is configured to adapt the primary control pressure of the main relay valve unit to a secondary control pressure for the anti-skid corrected control pressure for one of the at least two relay valves.

5. The brake system of claim 4, wherein the pneumatic brake control unit has at least one control pressure line on the main relay unit output side and/or at least one control pressure line portion on the main relay unit output side for each of the at least two relay valves, and wherein the at least one valve unit is arranged at least in each of the control pressure lines on the main relay unit output side and/or in each control pressure line portion on the main relay unit output side.

6. The brake system of claim 3, wherein the pneumatic brake control unit has a control unit configured to control the main relay valve unit and/or the at least one valve unit (25a, 25b) via a control line.

7. The brake system of claim 6, wherein a pressure sensor is arranged in a control pressure line on the main relay unit input side and is connected to the control unit for signaling purposes.

8. The brake system of claim 3, wherein the pneumatic brake control unit comprises an emergency brake control unit configured to control the main relay valve unit and/or the at least one valve unit via a control line.

9. The brake system of claim 8, wherein the emergency brake control unit has at least one emergency brake valve controlled by the control unit.

10. The brake system of claim 3, wherein at least one pressure sensor is provided in the control pressure line on the main relay unit output side between the main relay valve unit and at least one of the at least two relay valves and between at least one of the valve units and the respective relay valve.

11. The brake system of claim 1, wherein the at least two relay valves are arranged as local relay valves close to the brake cylinders assigned to them in each case, in the region of a bogie of the rail vehicle unit assigned to the respective brake cylinder.

12. A method for controlling a brake system for a rail vehicle, wherein the brake system including at least two brake cylinders, at least one pneumatic brake control unit assignable to at least one rail vehicle unit of the rail vehicle, and at least two relay valves, which are each arranged between the at least one pneumatic brake control unit and at least one of the at least two brake cylinders and to which a supply pressure is fed for conversion into a brake pressure, wherein the pneumatic brake control unit is connected to the at least two relay valves via a respective control pressure line and is configured to supply the at least two relay valves with an anti-skid-corrected control pressure via the respective control pressure line, the method comprising:
providing a supply pressure for each of the at least two relay valves;
controlling the at least two relay valves via the pneumatic brake control unit with an anti-skid-corrected control pressure; and
forwarding a respective brake pressure resulting from the supply pressure and the anti-skid-corrected control pressure to the at least one brake cylinder assigned to the respective relay valve.

13. The method of claim 12, further comprising adjusting the anti-skid-corrected control pressure via the main relay valve unit and/or the at least one valve unit.

14. A rail vehicle comprising a brake system claim 1, wherein the brake control unit is arranged in a rail vehicle unit of the rail vehicle and the at least two relay valves are each assigned to at least one bogie and arranged on or in the assigned bogie.

15. A non-transitory computer readable medium comprising software code which, when executed on a data processing unit, cause the data processing unit to perform the method recited in claim 12.

16. (canceled)

17. The brake system of claim 10, wherein at least one pressure sensor is provided in the control pressure line on the main relay unit output side between each of the valve units and the respective relay valve.

18. The method of claim 12, wherein the pneumatic brake control unit provides the anti-skid-corrected control pressure for at least one of the at least two relay valves independently of the anti-skid corrected control pressure for the at least one other of the at least two relay valves.

19. The method of claim 12, wherein the pneumatic brake control unit provides primary control pressure for the anti-skid-corrected control pressure for one of the at least two relay valves using a main relay valve unit.

20. The method of claim 19, wherein the pneumatic brake control unit has at least one valve unit in a control pressure line on the main relay unit output side between the main relay valve and at least one of the at least two relay valves, and wherein the method further comprises adapting the primary control pressure of the main relay valve unit to a secondary control pressure for the anti-skid corrected control pressure for one of the at least two relay valves using the at least one valve unit.

21. The method of claim 20, wherein the pneumatic brake control unit has at least one control pressure line on the main relay unit output side and/or at least one control pressure line portion on the main relay unit output side for each of the at least two relay valves, and wherein the at least one valve unit is arranged at least in each of the control pressure lines on the main relay unit output side and/or in each control pressure line portion on the main relay unit output side.

22. The method of claim 19, wherein the pneumatic brake control unit controls the main relay valve unit and/or the at least one valve unit via a control line.

23. The method of claim 22, wherein a pressure sensor is arranged in a control pressure line on the main relay unit input side and is connected to the control unit for signaling purposes.

24. The brake system of claim 19, wherein the pneumatic brake control unit includes an emergency brake control unit that controls the main relay valve unit and/or the at least one valve unit via a control line.

25. The method of claim 19, wherein the emergency brake control unit has at least one emergency brake valve controlled by the control unit.

26. The method of claim 19, wherein at least one pressure sensor is provided in the control pressure line on the main relay unit output side between the main relay valve unit and at least one of the at least two relay valves and between at least one of the valve units and one of the respective relay valves.

27. The method of claim 12, wherein the at least two relay valves are arranged as local relay valves close to the brake cylinders assigned to them in each case, in the region of a bogie of the rail vehicle unit assigned to the respective brake cylinder.
